(19) United States
(12) Patent Application Publication
(10) Pub. No.: US 2021/0229870 A1
(43) Pub. Date: Jul. 29, 2021

(54) MULTI-LAYER BAG AND METHOD FOR PRODUCING A MULTI-LAYER BAG

(71) Applicant: DY-PACK VERPACKUNGEN GUSTAV DYCKERHOFF GMBH, Wenden-Gerlingen (DE)

(72) Inventor: Eduard LISEK, Drolshagen (DE)

(21) Appl. No.: 17/053,567

(22) PCT Filed: May 27, 2019
(86) PCT No.: PCT/EP2019/063671

§ 371 Date: Dec. 9, 2020

(30) Foreign Application Priority Data
Jun. 12, 2018 (DE) 10 2018 114 001.0

(51) Int. Cl. B65D 30/08; B65D 30/18; B31B 70/10; B31B 70/26; B31B 70/16; D21H 27/36; D21H 27/10

(52) U.S. Cl. CPC B65D 31/04; B65D 31/08; B31B 70/10; B31B 2150/0012; B31B 70/16; D21H 27/36; D21H 27/10; B31B 70/262

(57) ABSTRACT

Multi-layer bag for bulk material, comprising at least one layer of material comprising paper or paper-like material, wherein two layers of material are formed by pieces of tube (22, 32) inserted telescopically in one another, wherein a first of the pieces of tube (22) inserted telescopically in one another has at one end (27) an overhang (U1) with respect to a second of the pieces of tube (32) inserted telescopically in one another.

The invention relates to a multilayer sack for bulk material such as cement, gypsum, pellets, cocoa powder, or other powdery foodstuffs, construction materials or chemicals.

Such sacks are known and are typically formed from two or more layers of a planar or web-shaped material, preferably paper and/or plastic. They are in particular used for the packaging and for the sale of powdery or fine grained bulk material. Typical sizes are 5 kg, 10 kg and 25 kg. A multilayer sack is described e.g. in DE 20 2014 000 194.

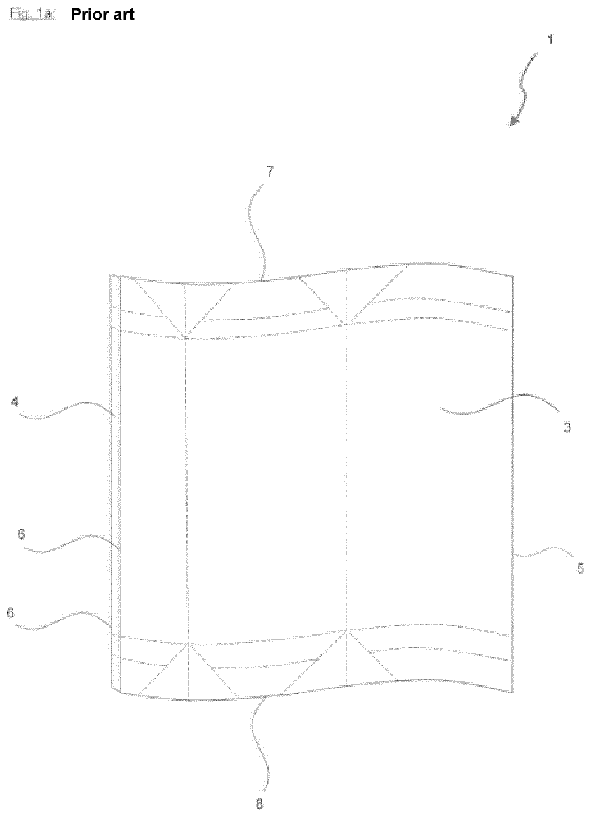

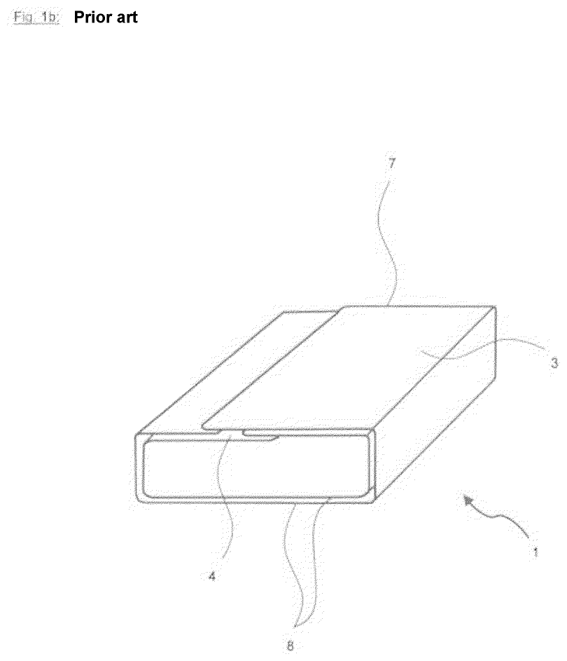

To manufacture such sacks, in a known manner, material webs of planar material, e.g. paper and/or film webs, are placed over one another in a so-called tubular fabric machine, are shaped into a continuous tube, and are divided into tubular pieces of suitable length from which finally the sack is formed, e.g. by means of a cross-base or block base fold. The multilayer tubular pieces comprise a plurality of single-layer tubular pieces that typically have the same length and are placed into one another such that their ends terminate in a flush manner with one another. A two-layer paper web section having such flush-terminating ends in accordance with the prior art is shown in FIG. 1a, a tubular piece formed therefrom in FIG. 1b. The sack bases are formed at the ends of the tubular pieces, e.g. in the form of a cross-base or block-base fold. A cross-base fold located at the top and bottom end of the tubular piece is indicated by dashed fold lines in FIG. 1a. FIG. 1c shows the folding closed of a cross base in the prior art. The base fold is fixed by a suitable adhesive bond as a rule toward the end of the sack manufacturing process. A top sheet is frequently additionally adhered for a better sealing and fixing of the base bond.

Due to the base fold and the adhering of the top sheet, the sack has a material thickness in the base region that is not needed as a rule. Since the sacks of the category are produced and sold in large volumes, even smaller material savings can produce relevant cost advantages.

It is therefore the object of the present invention to provide a multilayer sack in which material can be saved in the base region. The stability and leak tightness of the sack should advantageously be impaired as little as possible here.

The object is achieved in accordance with the invention by a sack having the features of claim 1. A method having the features of independent claim 12 is proposed in accordance with the invention for the sack manufacture. Advantageous embodiments are the subject of the dependent claims.

Provision is made in accordance with the invention that the sack comprises two material layers that are formed from tubular pieces that are inserted into one another and of which a first tubular piece has a projection at one end with respect to a second tubular piece. The two tubular pieces are accordingly located in a telescopic arrangement in which the two tubular pieces telescopically inserted into one another do not terminate flush with one another at at least one end. With typical sack formats, the projection suitably amounts to a few centimeters, preferably at least 2 cm, further preferably at least 3 cm, and even further preferably at least 4 cm. The projection advantageously amounts to at most 8 cm, further advantageously at most 6 cm, and even further advantageously at most 5 cm.

In addition to the first and second tubular pieces, further material layers can be present that can likewise be formed from tubular pieces that can be located outside and/or inside the first and/or second tubular pieces and also between them. These further tubular pieces can terminate at their ends flush with the first and/or second tubular pieces or can have a projection or be shortened with respect to them. Provision is therefore made in accordance with the invention that at least one tubular piece of the tubular pieces from which a multilayer paper sack is formed projects over another tubular piece at at least one end or that at least one tubular piece is shortened at at least one end with respect to another tubular piece.

A sack base at which the material effort has been reduced by the shortening of the shortened tubular piece can be formed at an end having a projecting tubular piece, with nevertheless a base fold closing the base being able to be established in the customary manner due to the projection of the projecting tubular piece.

The material saving can be restricted to the base region by a suitable selection of the projection or of the shortened portion. The invention thus makes a multilayer sack possible in which a material saving can be achieved in the base region by tubular piece projections and corresponding shortened portions, whereas a stable wall construction with all material layers is maintained in the region of the sack wall between the bases.

In an advantageous embodiment, the projection of the first tubular piece with respect to the second tubular piece is achieved in that the first tubular piece is formed as longer than the second tubular piece.

A projection of at least one tubular piece with respect to at least one other tubular piece is preferably formed at both ends of a multilayer tubular piece. Bases can then be formed in a material saving manner at both ends of the multilayer tubular piece. The projection is particularly advantageously formed equally wide at both ends.

In a preferred embodiment, of the two tubular pieces telescopically inserted into one another, the first has a projection at one end with respect to the second tubular piece and the second has a projection at the other end with respect to the first tubular piece. The two tubular pieces advantageously have the same length. Each of the two tubular pieces telescopically inserted into one another thus projects over the respective other tubular piece at another end. This embodiment is particularly advantageous from a technical production aspect because a projection can be produced at both ends with tubular pieces of equal lengths. A multilayer tubular piece is extended in a simple manner in that two equally long tubular pieces inserted into one another are telescopically pulled apart. Further tubular pieces of the same or different lengths terminating in a flush or non-flush manner can also be present, in addition to the first and second tubular pieces, in this embodiment.

The projection(s) is/are advantageously formed circumferentially around the sack, i.e. the projection(s) extends/extend around the entire tube circumference. The projection(s) is/are further advantageously equally wide circumferentially around the sack, i.e. along the entire tube circumference. Projections formed circumferentially around the sack circumference of equal width are easier to implement from a technical production aspect, in particular due to straight-line, smooth cuts or separation lines on the division of the paper webs and due to a staggered arrangement of paper web sections disposed above one another.

In further variants, the projection(s) can be formed circumferentially around the sack without or with an offset in the tube direction. In the design without an offset, a center line of the projection running around in the circumferential direction extends in a plane, while on a design of the projection with an offset, such a center line does not extend in a plane. In the embodiment without an offset, the projections can be established in a simple manner with a straight line cut or a smooth cut of the corresponding material web. In the embodiment with an offset, a non-straight line cut is required. An embodiment with an offset may produce advantages in the folding and sealing of the base.

The sack in accordance with the invention advantageously has two oppositely disposed bases that are formed in a cross-base or block-base folding manner at the ends of the tubular pieces. A tubular piece has the projection in accordance with the invention at at least one base, advantageously at both bases, and the base or bases is/are material saving in accordance with the invention.

In accordance with a further preferred embodiment, at least one base is additionally reinforced by a top sheet that is preferably adhesively bonded to the outermost tubular piece. The stability of the base and of the sack can be increased by a top sheet applied in such a manner. If the outermost tubular piece is shortened in the region of the respective base with respect to the or a further inwardly disposed tubular piece, the outermost tubular piece advantageously forms a frame that is adhesively bonded to the top sheet in the region of said base.

The preferred cross bases or block bases have side flaps extending substantially in parallel with the longitudinal base axis and corner folds at the ends of the longitudinal base axis. Such bases are typically folded closed by folding over the overlapping side flaps and the overlapping side flaps are adhesively bonded as a rule. It is sufficient with such bases if the overlap region of the side flaps is only formed by the projecting tubular piece or pieces, while the shortened tubular piece or pieces only extends/extend in the manner of a frame from the margin into the base region.

In another preferred embodiment, the first of the tubular pieces telescopically inserted into one another forms the outermost material layer of the sack and/or the second of the tubular pieces telescopically inserted into one another forms the innermost material layer of the sack. Further material layers or tubular pieces can be inserted therebetween and the first and second tubular pieces can have coatings, or can also not have coatings, on the inner and outer sides.

No further material layers are particularly preferably present beside the first and second tubular pieces so that a two-layer sack is present. If this embodiment is formed with equally long first and second tubular pieces, a particularly simple material saving two-layer sack is produced in which the projections are produced by telescopic pulling apart of the first and second tubular pieces.

At least one material layer of the sacks in accordance with the invention is formed from paper or from a paper-like material. Coated or laminated papers or other fibrous flat materials having comparable properties to paper can e.g. be considered as paper-like materials. Other material layers of the sacks in accordance with the invention can e.g. be formed from plastic films.

The method in accordance with the invention in accordance with claim 12 starts from the already known use of a tubular fabric machine in sack manufacture. In this process, material layers of a web-like planar material, for example paper webs and/or plastic film webs, are placed over one another in a tubular fabric machine, are divided into sections of suitable lengths, and are formed into tubular pieces. In accordance with the invention, the formation of the multilayer tubular pieces takes place such that at least one of the tubular pieces has a projection with respect to at least one other tubular piece in and/or against the direction of conveying of the tubular fabric machine.

The projection can advantageously be produced in that the projecting tubular piece is formed as longer or is cut to larger lengths than the non-projecting shortened tubular piece. This can e.g. be implemented in that the material web from which the projecting tubular piece is formed runs faster in the tubular fabric machine than the material web from which the shorter tubular piece is formed.

In another preferred embodiment of the method, the sack is manufactured with at least two tubular pieces of the same length that are inserted into one another and that are arranged staggered in the tubular fabric machine such that at least one tubular piece is disposed to the front or to the rear with respect to at least one another tubular piece in the conveying direction of the web-like material. The two tubular pieces are further advantageously brought into the aforesaid staggered arrangement by a staggered cutting of the associated material webs. It is thus possible with material webs running equally fast with multilayer tubular pieces to form a projection at both ends of the tubular pieces, with the projection particularly advantageously being of equal size at both ends.

In a preferred embodiment of the method in accordance with the invention, bases are formed, preferably in cross-base or block-base folds in a so-called bottom-laying machine, at the ends of the multilayer tubular pieces.

Embodiments of the invention will be explained in more detail with reference to the following Figures. There are shown:

FIGS. 1a/b: paper web sections or tubular pieces terminating in a flush manner for sack manufacture in accordance with the prior art;

FIG. 1c: the folding closed of a sack base known from the prior art;

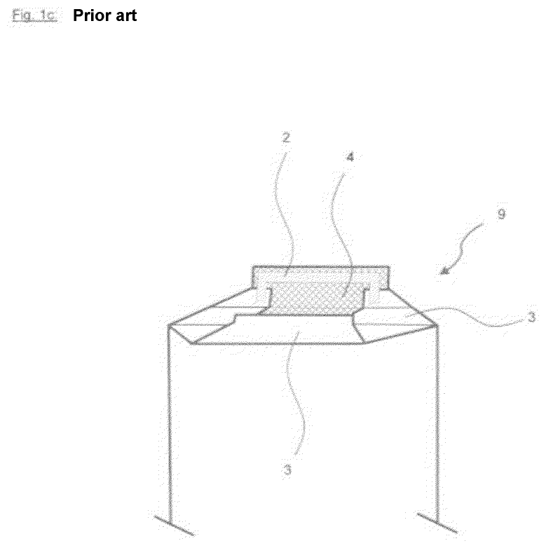

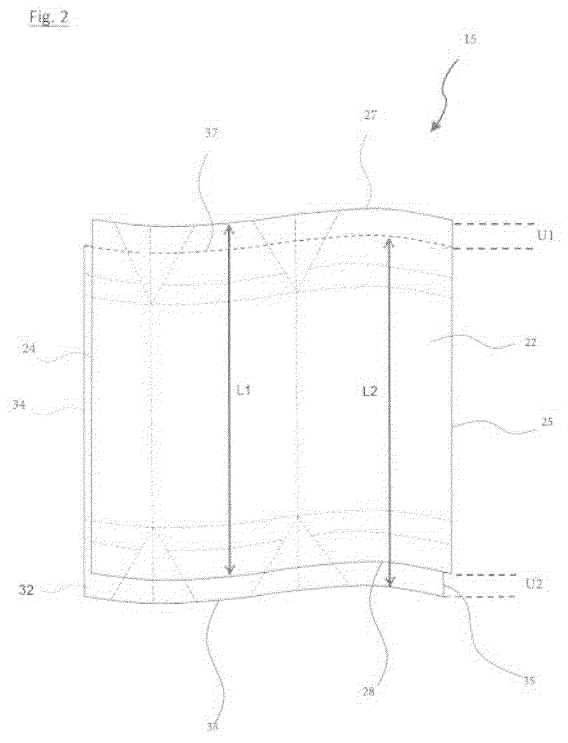

FIG. 2: a paper web section for a two-layer sack in accordance with the invention;

FIG. 2a: a paper web section for a variant of a two-layer sack in accordance with the invention;

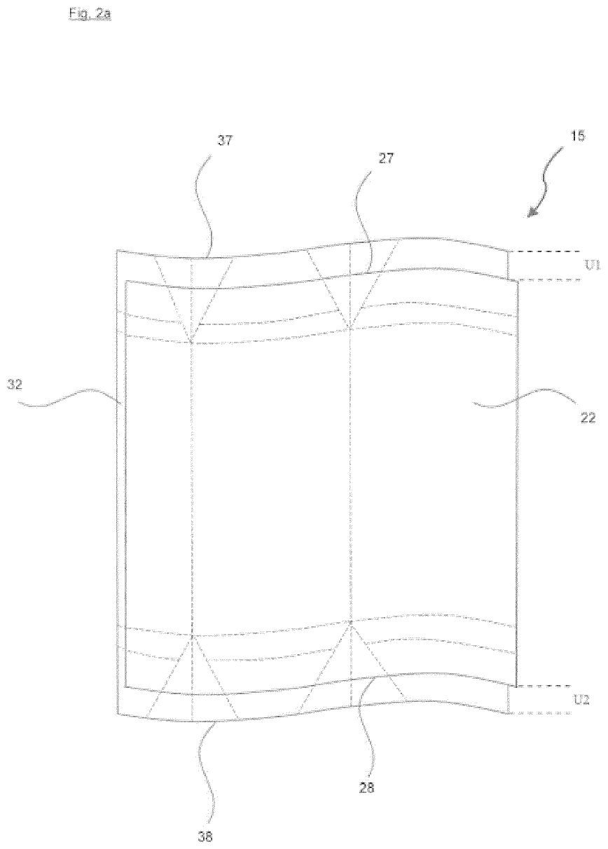

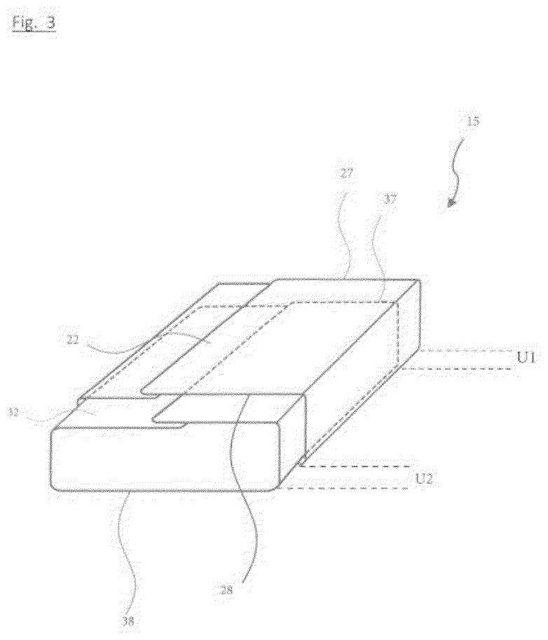

FIG. 3: a tubular piece for a two-layer sack in accordance with the invention;

FIG. 3a: a tubular web piece for variant of a two-layer sack in accordance with the invention;

FIG. 4: a plan view of the open cross base of a sack in accordance with the invention;

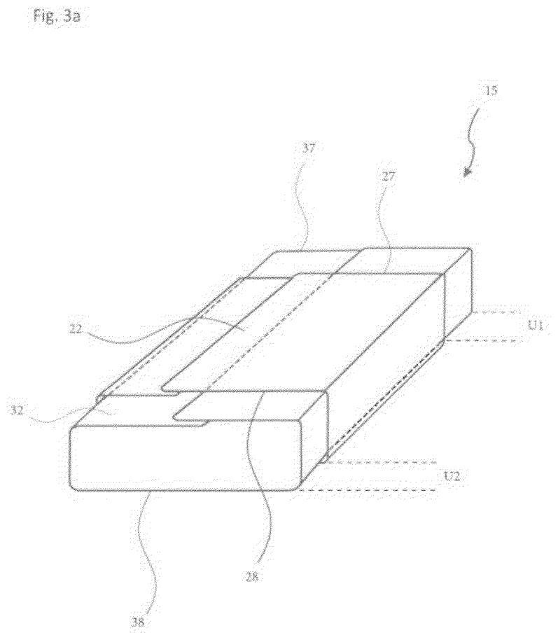

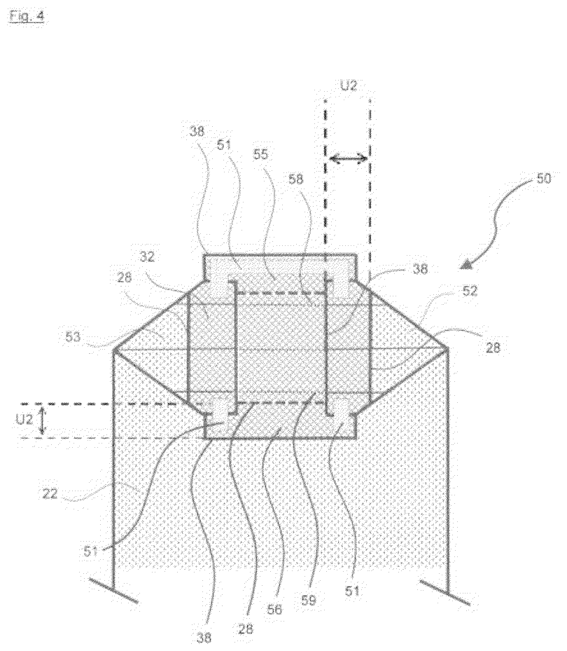

FIG. 5: an oblique view of the partially folded closed cross base of a sack in accordance with the invention;

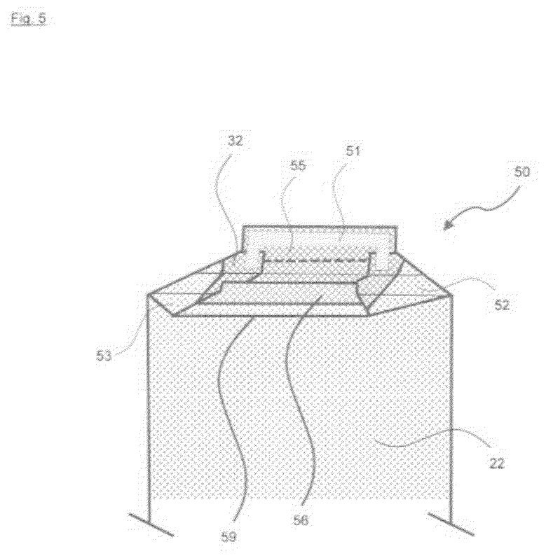

FIG. 6: the closed cross base of a sack in accordance with the invention;

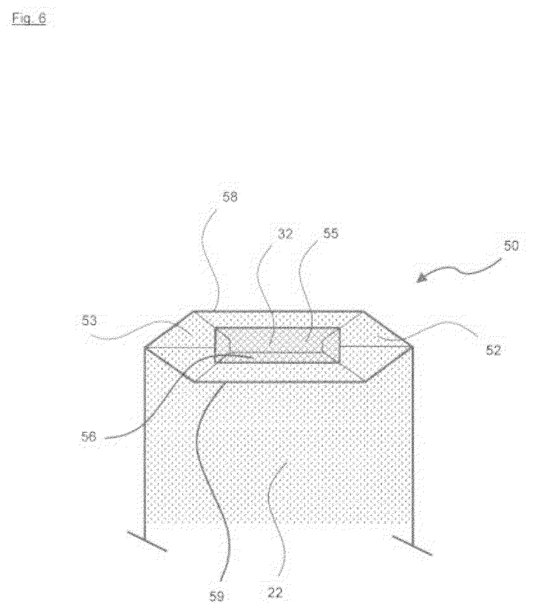

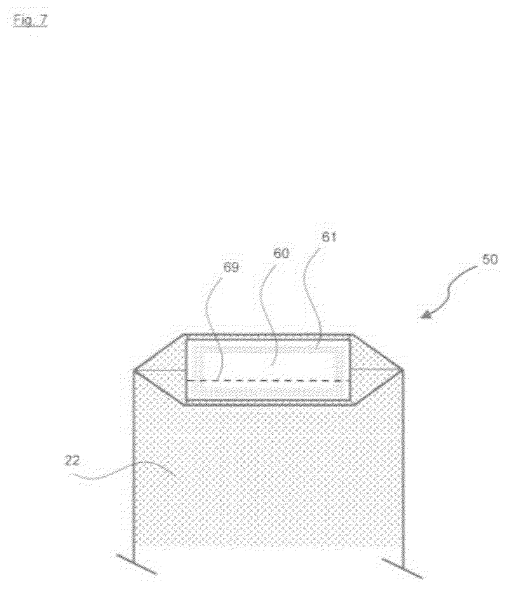

FIG. 7: the closed base of a sack in accordance with the invention with a top sheet;

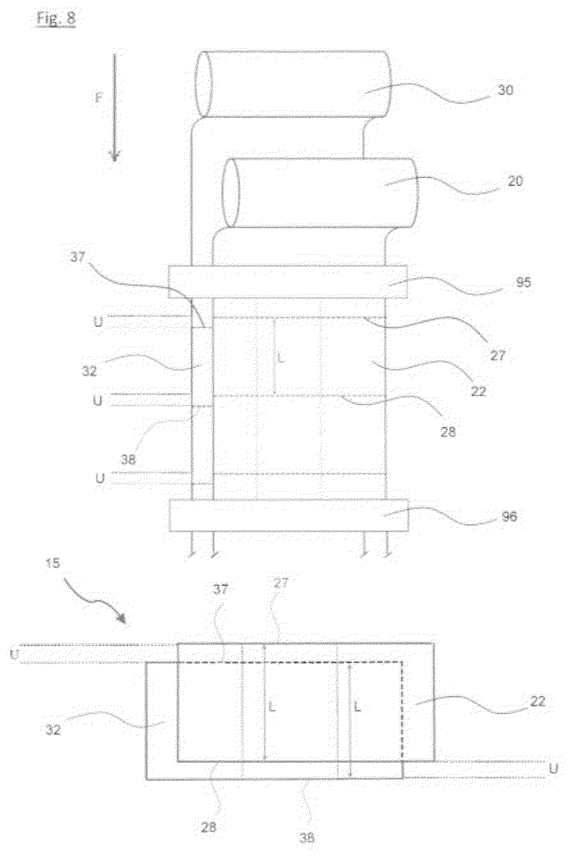

FIG. 8: a schematic representation of the cutting to size of paper webs for a two-layer sack in accordance with the invention; and

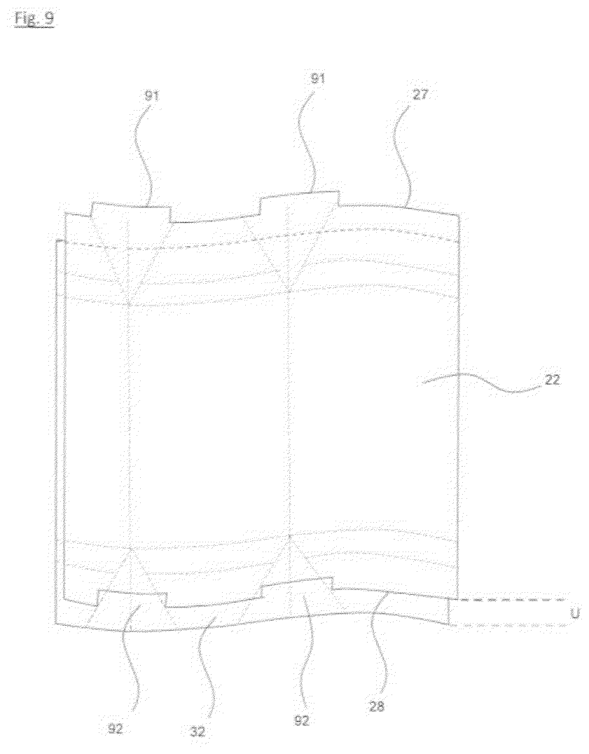

FIG. 9: a paper web section fora two-layer sack in accordance with the invention with a projection with projection.

FIG. 1a shows a two-layer paper web section 1 for manufacturing a two-layer paper sack in accordance with the prior art. The upper paper layer 3 forms the outer layer of the completed sack; the paper layer 4 disposed thereunder forms the inner layer of the sack wall. The right and left margins 5 and 6 of the material layers 3 and 4 are each connected to form a tube that is shown in FIG. 1b. In FIG. 1a, the left margin 6 of both material layers 3 and 4 can be seen, while the right margin 5 of only the material layer 3 can be seen. Shaped to form a tube, the two-layer paper section in accordance with FIG. 1b forms a two-layer tubular piece 1 having the outer tubular piece 3 and the inner tubular piece 4, with the two paper layers or tubular piece layers 3 and 4 terminating flush with one another at the ends 7 and 8. The base fold of the sack is formed in the regions of the two ends 7 and 8, with a cross-base fold being indicated in dashed lines in FIG. 1a. FIG. 1c shows the folding closed of the base 9 when a cross-base sack in accordance with the prior art is formed from the paper web section or tubular piece 1 in accordance with FIGS. 1a/b. As can be seen, an increase in the material thickness occurs in the region of the base fold due to the placing of fold sections over one another.

FIG. 2 shows a two-layer paper web section 15 for manufacturing a two-layer sack in accordance with the invention. The upper paper layer 22 forms the outer layer and the layer 32 forms the inner layer of the sack. A two-layer tubular piece 15 having the first tubular piece 22 and the second tubular piece 32 is formed by connecting the respective left and right side margins 24, 34 and 25, 35, as schematically shown in FIG. 3. In this respect, the second tubular piece 32 has a projection U2 at its front end 38 with respect to the front end 28 of the first tubular piece 22 and the first tubular piece 22 has a projection U1 at its rear end 27 with respect to the rear end 37 of the second tubular piece 32. This means that the first tubular piece 22 is shortened by the projection U2 at its front end 28 with respect to the second tubular piece 32 and the second tubular piece 32 is shortened by the projection U1 at its rear end 37 with respect to the first tubular piece 22.

The projections U1 and U2 are formed in substantially the same size at both ends of the two-layer tubular piece and both tubular pieces 22 and 32 have substantially the same length L1=L2 between the ends 27, 37 and 28, 38. The projections U1 and U2 are accordingly implemented in that the paper layers or tubular pieces 22 and 32 are arranged offset from one another in the direction of the length L1=L2 that corresponds to the conveying direction F of the paper web in the tubular fabric machine. The offset arrangement of the inner paper length 32 has the result in the tube formation that the tubular pieces 22 and 32 are telescopically inserted into one another, with the telescopic extension corresponding to the projection U1=U2 and the two tubular pieces telescopically inserted into one another being arranged such that the projection U1=U2 is formed at both ends 27 and 28. The embodiment in accordance with FIGS. 2 and 3 can be implemented particularly easily from a technical production aspect because the paper layers 22 and 32 can be cut to the same length in the tubular fabric machine, that is web sections of the same length are required for both material layers. The two-layer tubular piece has a length increased with respect to the length L1=L2 of the individual layers. A two-layer sack having a greater sack length and a greater filling volume can thereby be particularly easily manufactured.

FIGS. 2a and 3a show a two-layer paper web section 15 or a two-layer tubular piece 15 for a variant of a two-layer sack in accordance with the invention in which the lower paper layer 32 or the inner tubular piece 32 is formed as longer than the upper paper layer 22 or the outer tubular piece 22. In this variant, the inner tubular piece 32 has a projection U1 at its rear end 37 and a projection U2 at its front end 38 with respect to the outer tubular piece 22. The projections U1 and U2 are particularly advantageously of equal size. The material saving is achieved in this variant in that the rear end 27 of the outer tubular piece is shortened by the projection U1 with respect to the inner tubular piece 32 and the front end 28 of the outer tubular piece 22 is shortened by the projection U2 with respect to the inner tubular piece 32.

As shown in FIGS. 2, 2a, 3, and 3a, the projections U1 and U2 are formed circumferentially around the sack, i.e. the projections extend around along the entire tube circumference at the tubular piece ends 27/37 and 28/38. The two projections U1 and U2 furthermore have the same width continuously all around, i.e. the projections U1 and U2 are of equal size at every point all around. The projections U1 and U2 are furthermore formed all around without an offset. The projections U1 and U2 are between 3 cm and 5 cm wide in a suitable manner.

FIG. 4 shows the open cross base 50 of a sack in accordance with the invention that is formed from the two-layer paper section 15 or tubular piece 15 shown in FIGS. 2 and 3. In this respect, the cross base 50 is formed at the tubular piece end 28/38 at which the inner tubular piece 32 projects by the projection U2 with respect to the outer tubular piece 22. The corner folds 52 and 53 as well as the side flaps 55 and 56 that are folded closed about the side fold lines 58 and 59 to close the base are characteristic for the cross-base fold. The tubular piece 22 is provided with a dot/angle pattern in FIG. 4 and the inner second tubular piece 32 is provided with a cross hatching. Due to the projection U2 of the end 38 of the second tubular piece 32 with respect to the end 28 of the first tubular piece 22, a center region is located in the region of the base in which the corner folds 52 and 52 and the side flaps 55 and 56 are only formed by the tubular piece 32 and are not covered by the tubular piece 22. A closure of the base while saving material can thus be achieved due to the projection U2 on the folding closed of the side flaps 55 and 56, with the saving resulting from the material of the first or outer tube layer 22 saved in the region of the projection. The adhesive bonding of the base is established with a suitable adhesive contour 51.

FIG. 5 shows the folding closed of the base 50 of a sack in accordance with the invention, with the front side flap 62 being folded closed first and then the rear side flap 55. The base folded closed is fixed by the adhesive bond 51.

FIG. 6 shows the base 50 of a sack in accordance with the invention folded closed and adhesively bonded. The outer tubular piece 22 forms a frame that extends along the margin of the base 50 that leaves a window in the center in which the overlap of the projecting region of the side flaps 55 and 56 is visible. The projecting region of the inner tubular piece 32 provides that the base is completely closed.

FIG. 7 shows a sack base 5o that is formed in accordance with the invention and this is additionally reinforced by a top sheet 60. The adhesive contour 61 of the top sheet is formed here such that the top sheet is adhesively bonded to the outer tubular piece 22 or to the frame formed by it in the region of the base. To facilitate the tearing open of the top sheet, a tear-open strip 69 is provided in it.

FIG. 8 illustrates a stage in the manufacturing process in accordance with the invention for sacks in accordance with the invention, namely the production of a two-layer paper web section 15 in which a respective paper web section or tubular piece 22, 32 has a projection U at a respective end with respect to the respective other paper web section or tubular piece 22, 32. Paper webs are unwound from rollers 20 and 30 and are placed over one another in the tubular fabric machine. The paper web 20 is for the outer layer or the outer first tubular piece 22 and the paper web 30 is for the inner layer or the inner second tubular piece 32 of the sacks in accordance with the invention. In a first station 95 of the tubular fabric machine, the paper webs are provided with straight-line transverse perforations 27, 28, 37, 38 that later form the upper and lower margins 27, 28, 37, 38 of the first and second tubular pieces 22, 32. In a second station 96 of the tubular fabric machine, the paper web sections or tubular sections 22 and 32 formed therefrom are separated. As can be seen, two-layer paper web sections or tubular pieces 22, 32 are formed in which the upper end 27 of the first tubular piece 22 has a projection U with respect to the upper end 37 of the second tubular piece (32) and the lower end 38 of the second tubular piece 32 has a projection U with respect to the lower end 28 of the first tubular piece 22. In this respect, the paper web sections or tubular pieces 22 and 32 have the same length L in the conveying direction F of the tubular fabric machine. Only the perforation lines or cutting lines are arranged offset or staggered from one another, with the paper web section 32 being displaced to the rear in the conveying direction with respect to the section 22. It is possible in this manner to manufacture paper web sections of the same length or tubular pieces 22, 32 of the same length for the outer and inner layers of a two-layer sack in which a respective projection U of a tubular piece is present at both ends of the two-layer tubular piece so that both bases of the sack can be formed as material saving in accordance with the invention.

The folding, folding closed, and adhesive bonding of the bases takes place in a bottom-laying machine not shown in FIG. 8.

FIG. 9 illustrates a two-layer paper web section in which the upper and lower ends 27, 38 of the upper or first paper layer 22, that forms the first or outer tubular piece 22, is not cut in a straight line. The upper end 27 rather has projecting tabs 91 and the lower end 28 has cutouts 92 complementary thereto. In this embodiment, the projection U is not equally wide peripherally around the tube circumference and has an offset along the circumference due to the tabs 91 and the cutouts 92. A material saving in the base formation can also be achieved in accordance with the invention with the embodiment shown in FIG. 9, with specific advantages in the base folding being able to be achieved with the tabs 91 and cutouts 92.

1. A multilayer sack for bulk material having at least one material layer of paper or paper-like material, wherein
two material layers are formed from tubular pieces (22, 32) telescopically inserted into one another, and
a first one of the tubular pieces (22) telescopically inserted into one another has a projection (U1) at one end (27) with respect to a second one of the tubular pieces (32) telescopically inserted into one another.

2. A sack in accordance with claim 1, wherein the first one or the second one of the tubular pieces (22, 32) telescopically inserted into one another has a projection (U2) at the other end (28, 38) with respect to the respective other one of the tubular pieces (22, 32) telescopically inserted into one another.

3. A sack in accordance with claim 1, wherein the second one of the tubular pieces (32) telescopically inserted into one another has a projection (U2) at the other end (38) with respect to the first one of the tubular pieces (22) telescopically inserted into one another.

4. A sack in accordance with claim 3, wherein the first one and the second one of the tubular pieces (22, 32) telescopically inserted into one another have substantially the same length (L, L1, L2).

5. A sack in accordance with claim 1, wherein one projection or both projections (U, U1, U2) is/are formed circumferentially around the sack.

6. A sack in accordance with claim 1, wherein one projection or both projections (U, U1, U2) has/have the same width circumferentially around the sack.

7. A sack in accordance with claim 1, wherein one projection or both projections (U, U1, U2) is/are formed with an offset in the tube direction circumferentially around the sack.

8. A sack in accordance with claim 1, wherein the sack has two oppositely disposed bases (50) and a side wall extending between the bases, with the bases (50) preferably being formed in a cross-base or block-base folding manner at the ends (27, 38, 37, 38) of the tubular pieces (22, 32) telescopically inserted into one another, and with the projection or projections (U, U1, U2) being configured in width such that the tubular piece not projecting at the respective end reaches into the base region there and the base or bases is/are advantageously reinforced by a top sheet (60).

9. A sack in accordance with claim 8, wherein the bases are formed as cross bases or block bases having side flaps (55, 56) extending substantially in parallel with the longitudinal base axis, and the projection or projections (U, U1, U2) are configured in their widths such that the tubular piece not projecting at the respective end does not reach into the overlap region of the side flaps of the base fold.

10. A sack in accordance with claim 1, wherein the first one of the tubular pieces (22) telescopically inserted into one another forms the outermost material layer of the sack; and/or the second one of the tubular pieces (32) telescopically inserted into one another forms the innermost material layer of the sack; and/or no further material layers are arranged between the first and second tubular pieces (22, 32).

11. A sack in accordance with claim 10, wherein a plastic film is arranged as a further material layer between the outwardly disposed and the inwardly disposed tubular pieces (22, 32) telescopically inserted into one another; and/or the outwardly disposed one of the tubular pieces telescopically inserted into one another is coated, in particular plastic coated, at its inner and/or outer side; and/or the inwardly disposed one of the tubular pieces telescopically inserted into one another is coated, in particular plastic coated, at its inner and/or outer side.

12. A method of manufacturing a multilayer sack from at least two layers of a web-like planar material, in particular paper and/or plastic, in which the material layers are placed over one another in a tubular fabric machine and are divided into pieces and are shaped into multilayer tubular pieces (22, 32) such that the multilayer tubular piece comprises an at least two-layer telescopic tubular piece, wherein the telescopic tubular piece comprises at least two tubular pieces (22, 32) telescopically inserted into one another, and at least one of the tubular pieces (22) telescopically inserted into one another has a projection (U) with respect to at least one other one of the tubular pieces (32) telescopically inserted into one another in and/or against the conveying direction (F) of the tubular fabric machine.

13. A method in accordance with claim 12, wherein the two tubular pieces telescopically inserted into one another have substantially the same length (L).

14. A method in accordance with claim 13, wherein the tubular pieces telescopically inserted into one another are brought into the staggered arrangement by a staggered cutting of the associated material webs.

15. A sack in accordance with claim 4, wherein one projection or both projections (U, U1, U2) is/are formed circumferentially around the sack.

16. A sack in accordance with claim 3, wherein one projection or both projections (U, U1, U2) is/are formed circumferentially around the sack.

17. A sack in accordance with claim 2, wherein one projection or both projections (U, U1, U2) is/are formed circumferentially around the sack.

18. A sack in accordance with claim 17, wherein one projection or both projections (U, U1, U2) has/have the same width circumferentially around the sack.

19. A sack in accordance with claim 16, wherein one projection or both projections (U, U1, U2) has/have the same width circumferentially around the sack.

20. A sack in accordance with claim 15, wherein one projection or both projections (U, U1, U2) has/have the same width circumferentially around the sack.
